(19) United States
(12) Patent Application Publication
(10) Pub. No.: US 2022/0063201 A1
(43) Pub. Date: Mar. 3, 2022

(54) METHOD AND SYSTEM FOR IMPROVING COLOR UNIFORMITY IN INKJET PRINTING

(71) Applicant: Stratasys Ltd., Rehovot (IL)

(72) Inventor: Alexander LIBINSON, Holon (IL)

(73) Assignee: Stratasys Ltd., Rehovot (IL)

(21) Appl. No.: 17/419,816

(22) PCT Filed: Dec. 31, 2019
(86) PCT No.: PCT/IL2019/051445

§ 371 Date: Jun. 30, 2021

Related U.S. Application Data
(60) Provisional application No. 62/786,555, filed on Dec. 31, 2018.

(51) Int. Cl. B29C 64/393; B41J 2/21; B29C 64/209; B29C 64/112

(52) U.S. Cl. CPC B29C 64/393; B41J 2/2139; B33Y 10/00; B29C 64/112; B29C 64/209

(57) ABSTRACT

A method of printing comprises: detecting a defective nozzle in a first array of nozzles; disabling a nozzle in a second array of nozzles; dispensing a first material formulation from nozzles of the first array, other than the defective nozzle; and dispensing a second material formulation from nozzles of the second array, other than the disabled nozzle.

### RELATED APPLICATION

This application claims the benefit of priority under 35 USC 119(e) of U.S. Provisional Patent Application No. 62/786,555 filed Dec. 31, 2018, the contents of which are incorporated herein by reference in their entirety.

### FIELD AND BACKGROUND OF THE INVENTION

The present invention, in some embodiments thereof, relates to inkjet printing, and, more particularly, but not exclusively, to a method and system for improving color uniformity in inkjet printing, such as, but not limited to, three-dimensional inkjet printing.

Additive manufacturing (AM) is a technology enabling fabrication of arbitrarily shaped structures directly from computer data via additive formation steps. The basic operation of any AM system consists of slicing a three-dimensional computer model into thin cross sections, translating the result into two-dimensional position data and feeding the data to control equipment which fabricates a three-dimensional structure in a layerwise manner.

Additive manufacturing entails many different approaches to the method of fabrication, including three-dimensional (3D) printing such as 3D inkjet printing, electron beam melting, stereolithography, selective laser sintering, laminated object manufacturing, fused deposition modeling and others.

Some 3D printing processes, for example, 3D inkjet printing, are being performed by a layer by layer inkjet deposition of building materials. Thus, a building material is dispensed from a dispensing head having a set of nozzles to deposit layers on a supporting structure. Depending on the building material, the layers may then be cured or solidified using a suitable device.

Various three-dimensional printing techniques exist and are disclosed in, e.g., U.S. Pat. Nos. 6,259,962, 6,569,373, 6,658,314, 6,850,334, 7,183,335, 7,209,797, 7,225,045, 7,300,619, 7,479,510, 7,500,846, 7,962,237 and 9,031,680, all of the same Assignee, the contents of which are hereby incorporated by reference.

Additional background art includes European Patent No. 1 572 463, U.S. Pat. No. 7,209,797, and U.S. Published Application No. 20050104241.

### SUMMARY OF THE INVENTION

According to an aspect of some embodiments of the present invention there is provided a method of printing using an inkjet printing system having plurality of arrays of nozzles. The method comprises: detecting a defective nozzle in a first array of nozzles; disabling a nozzle in a second array of nozzles; dispensing a first material formulation from nozzles of the first array, other than the defective nozzle; and dispensing a second material formulation from nozzles of the second array, other than the disabled nozzle.

According to some embodiments of the invention the method comprises selecting the nozzle in the second array so as to locally maintain a ratio between the first and the second material formulations.

According to some embodiments of the invention a location of the defective nozzle along the first array, and a location of the disabled nozzle along the second array of nozzles, are within 0 to 5 array pitch units from each other.

According to some embodiments of the invention the method comprises detecting a plurality of defective nozzles in the first array of nozzles, disabling a plurality of nozzles in the second array of nozzles; dispensing the first material formulation from nozzles of the first array, other than the defective nozzles; and dispensing the second material formulation from nozzles of the second array, other than the disabled nozzles.

According to some embodiments of the invention the first material formulation and the second material formulation are of different colors.

According to some embodiments of the invention the first material formulation and the second material formulation have different mechanical properties.

According to some embodiments of the invention the first material formulation and the second material formulation have different electrical properties.

According to some embodiments of the invention the first material formulation and the second material formulation have different magnetic properties.

According to some embodiments of the invention the dispensing of the first material formulation, and the dispensing of the second material formulation is in an interlaced manner.

According to some embodiments of the invention the first array of nozzles and the second array of nozzles are both located in one dispensing head.

According to some embodiments of the invention the first array of nozzles is located in a first dispensing head, and the second array of nozzles is located in a second dispensing head.

According to some embodiments of the invention the method comprises detecting an additional defective nozzle intermittently with the dispensing of the first and the second material formulations.

According to some embodiments of the invention the detection is executed automatically by an optical scanner.

According to some embodiments of the invention the inkjet printing system is a three-dimensional inkjet printing system, and the first and the second material formulations, are respectively a first and a second building material formulations.

According to some embodiments of the invention the inkjet printing system is a two-dimensional inkjet printing system, and the first and the second material formulations, are respectively a first and a second ink material formulations.

According to an aspect of some embodiments of the present invention there is provided an inkjet printing system. The system comprises: a plurality of arrays of nozzles; and a controller configured for receiving information pertaining to a defective nozzle in a first array of nozzles, for disabling a nozzle in a second array of nozzles, and for controlling the first array to dispense a first material formulation from nozzles of the first array, other than the defective nozzle, and for controlling the second array to dispense a second material formulation from nozzles of the second array, other than the disabled nozzle.

According to some embodiments of the invention the system comprises: an optical scanner; and an image processor configured for receiving scans from the optical scanner, processing the scans to detect the defective nozzle in the first array of nozzles, and transmitting the information to the controller.

According to some embodiments of the present invention the controller is configured for selecting the nozzle in the second array so as to locally maintain a ratio between the first and the second material formulations.

According to some embodiments of the present invention a location of the defective nozzle along the first array, and a location of the disabled nozzle along the second array of nozzles, are within 0 to 5 array pitch units from each other.

According to some embodiments of the present invention the controller is configured for detecting a plurality of defective nozzles in the first array of nozzles, disabling a plurality of nozzles in the second array of nozzles; dispensing the first material formulation from nozzles of the first array, other than the defective nozzles; and dispensing the second material formulation from nozzles of the second array, other than the disabled nozzles.

According to some embodiments of the present invention the first array of nozzles and the second array of nozzles are both located in one dispensing head.

According to some embodiments of the present invention the first array of nozzles is located in a first dispensing head, and the second array of nozzles is located in a second dispensing head.

According to some embodiments of the present invention the controller is configured for detecting an additional defective nozzle intermittently with the dispensing of the first and the second material formulations.

According to some embodiments of the present invention the system is a three-dimensional inkjet printing system, wherein the first and the second material formulations, are respectively a first and a second building material formulations.

According to some embodiments of the present invention the system is a two-dimensional inkjet printing system, and the first and the second material formulations, are respectively a first and a second ink material formulations.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads according to some embodiments of the present invention;

FIGS. 3A and 3B are schematic illustrations demonstrating coordinate transformations according to some embodiments of the present invention;

FIG. 4 is a schematic illustration of an array of nozzles, and a top view of a layer formed by the array;

FIG. 5 is a schematic illustration of two arrays of nozzles, and a top view of a layer formed by the two arrays, according to some embodiments of the present invention;

FIG. 6 is a flowchart diagram of a printing method, according to some exemplary embodiments of the present invention; and

FIG. 7 shows results of experiments performed according to some embodiments of the present invention for improving color uniformity.

### DESCRIPTION OF SPECIFIC EMBODIMENTS OF THE INVENTION

The present invention, in some embodiments thereof, relates to inkjet printing, and, more particularly, but not exclusively, to a method and system for improving color uniformity in inkjet printing, such as, but not limited to, three-dimensional inkjet printing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The method and system of the present embodiments manufacture three-dimensional objects based on computer object data in a layerwise manner by forming a plurality of layers in a configured pattern corresponding to the shape of the objects. The computer object data can be in any known format, including, without limitation, a Standard Tessellation Language (STL) or a StereoLithography Contour (SLC) format, an OBJ File format (OBJ), a 3D Manufacturing Format (3MF), an OBJ File format (OBJ), a 3D Manufacturing Format (3MF), Virtual Reality Modeling Language (VRML), Additive Manufacturing File (AMF) format, Drawing Exchange Format (DXF), Polygon File Format (PLY) or any other format suitable for Computer-Aided Design (CAD).

The term “object” as used herein refers to a whole object or a part thereof.

Each layer is formed by an additive manufacturing apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material formulation, and which type of building material formulation is to be delivered thereto. The decision is made according to a computer image of the surface.

In preferred embodiments of the present invention the AM comprises three-dimensional printing, more preferably three-dimensional inkjet printing. In these embodiments a building material formulation is dispensed from a printing head having one or more arrays of nozzles to deposit building material formulation in layers on a supporting structure. The AM apparatus thus dispenses building material formulation in target locations which are to be occupied and leaves other target locations void. The apparatus typically includes a plurality of arrays of nozzles, each of which can be configured to dispense a different building material formulation. Thus, different target locations can be occupied by different building material formulations. The types of building material formulations can be categorized into two major categories: modeling material formulation and support material formulation. The support material formulation serves as a supporting matrix or construction for supporting the object or object parts during the fabrication process and/or other purposes, e.g., providing hollow or porous objects. Support constructions may additionally include modeling material formulation elements, e.g. for further support strength.

The modeling material formulation is generally a composition which is formulated for use in additive manufacturing and which is able to form a three-dimensional object on its own, i.e., without having to be mixed or combined with any other substance.

The final three-dimensional object is made of the modeling material formulation or a combination of modeling material formulations or modeling and support material formulations or modification thereof (e.g., following curing). All these operations are well-known to those skilled in the art of solid freeform fabrication.

In some exemplary embodiments of the invention an object is manufactured by dispensing two or more different modeling material formulations, each material formulation from a different array of nozzles (belonging to the same or different printing heads) of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are both located in separate the same printing head.

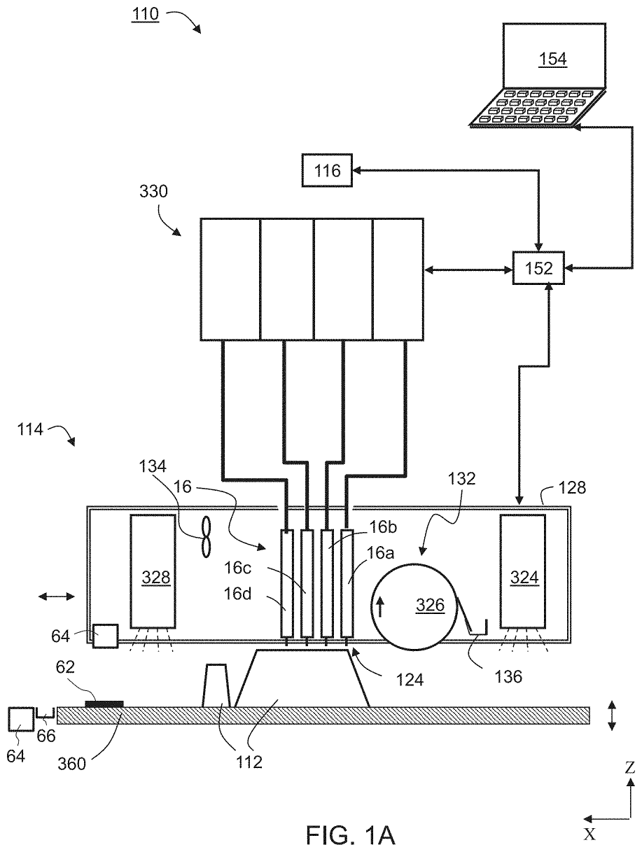

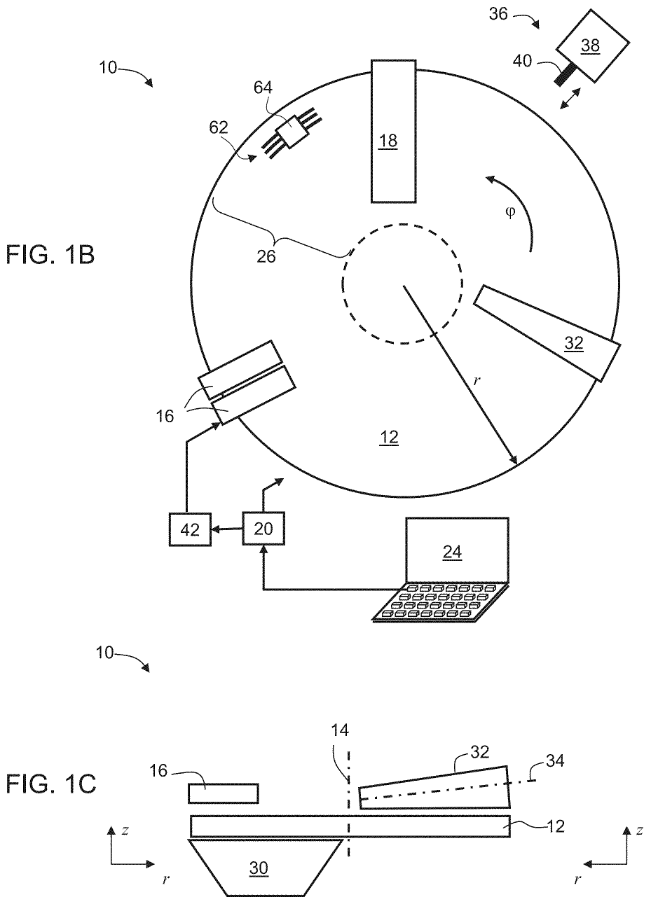

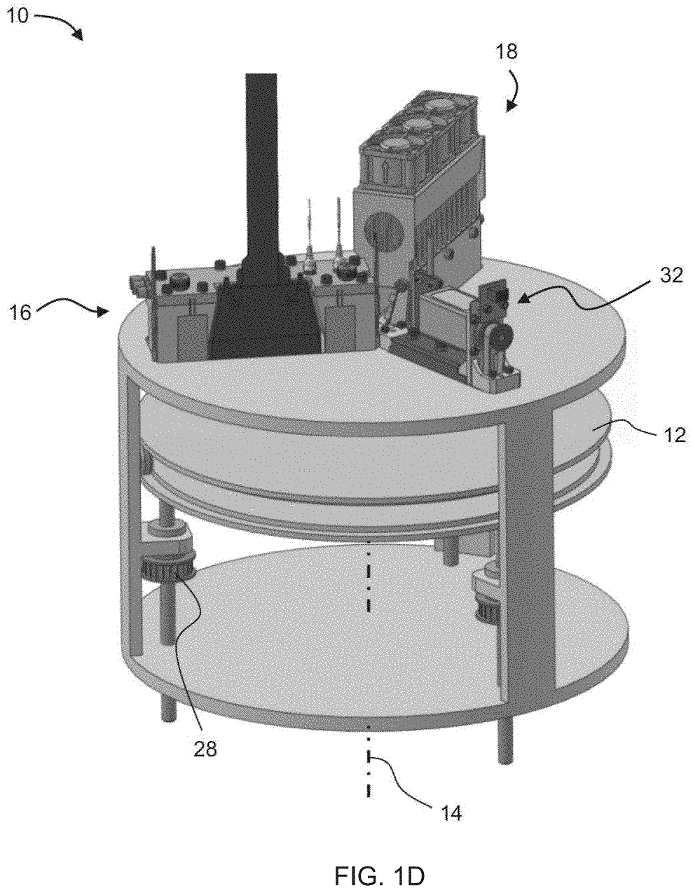

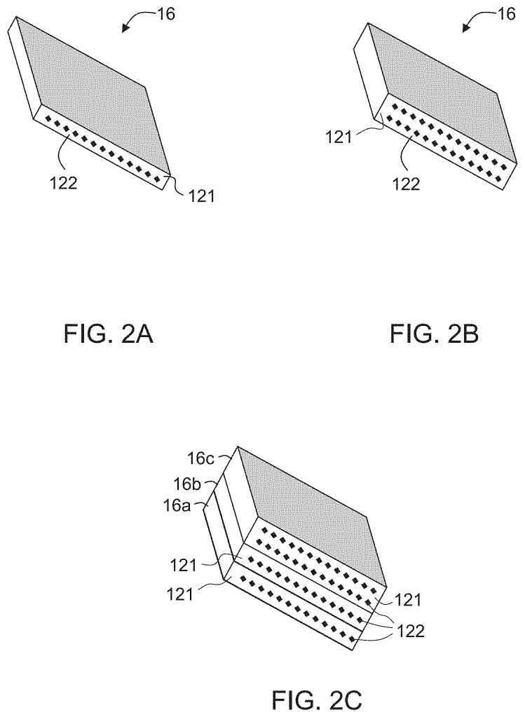

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

Preferably, but not obligatorily, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. Generally, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to ±10%.

For example, for a=1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise a solidifying device 324 which can include any device configured to emit light, heat or the like that may cause the deposited material formulation to harden. For example, solidifying device 324 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 324 serves for curing or solidifying the modeling material formulation.

In addition to solidifying device 324, apparatus 114 optionally and preferably comprises an additional radiation source 328 for solvent evaporation. Radiation source 328 optionally and preferably generates infrared radiation. In various exemplary embodiments of the invention solidifying device 324 comprises a radiation source generating ultraviolet radiation, and radiation source 328 generates infrared radiation.

In some embodiments of the present invention apparatus 114 comprises cooling system 134 such as one or more fans or the like.

The printing head(s) and radiation source are preferably mounted in a frame or block 128 which is preferably operative to reciprocally move over a tray 360, which serves as the working surface. In some embodiments of the present invention the radiation sources are mounted in the block such that they follow in the wake of the printing heads to at least partially cure or solidify the material formulations just dispensed by the printing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 132, e.g. a roller 326. Leveling device 326 serves to straighten, level and/or establish a thickness of the newly formed layer prior to the formation of the successive layer thereon. Leveling device 326 preferably comprises a waste collection device 136 for collecting the excess material formulation generated during leveling. Waste collection device 136 may comprise any mechanism that delivers the material formulation to a waste tank or waste cartridge.

In use, the printing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the printing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 326, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layerwise manner.

In another embodiment, tray 360 may be displaced in the Z direction between forward and reverse passages of the printing head of unit 16, within the layer. Such Z displacement is carried out in order to cause contact of the leveling device with the surface in one direction and prevent contact in the other direction.

System 110 optionally and preferably comprises a building material formulation supply system 330 which comprises the building material formulation containers or cartridges and supplies a plurality of building material formulations to fabrication apparatus 114.

A control unit 152 controls fabrication apparatus 114 and optionally and preferably also supply system 330. Control unit 152 typically includes an electronic circuit configured to perform the controlling operations. Control unit 152 preferably communicates with a data processor 154 which transmits digital data pertaining to fabrication instructions based on computer object data, e.g., a CAD configuration represented on a computer readable medium in a form of a Standard Tessellation Language (STL) format or the like. Typically, control unit 152 controls the voltage applied to each printing head or each nozzle array and the temperature of the building material formulation in the respective printing head or respective nozzle array.

Once the manufacturing data is loaded to control unit 152 it can operate without user intervention. In some embodiments, control unit 152 receives additional input from the operator, e.g., using data processor 154 or using a user interface 116 communicating with unit 152. User interface 116 can be of any type known in the art, such as, but not limited to, a keyboard, a touch screen and the like. For example, control unit 152 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The radial direction r in system 10 enacts the indexing direction y in system 110, and the azimuthal direction φ enacts the scanning direction x in system 110. Therefore, the radial direction is interchangeable referred to herein as the indexing direction, and the azimuthal direction is interchangeable referred to herein as the scanning direction.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, OBJ File format (OBJ), 3D Manufacturing Format (3MF), Virtual Reality Modeling Language (VRML), Additive Manufacturing File (AMF) format, Drawing Exchange Format (DXF), Polygon File Format (PLY) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

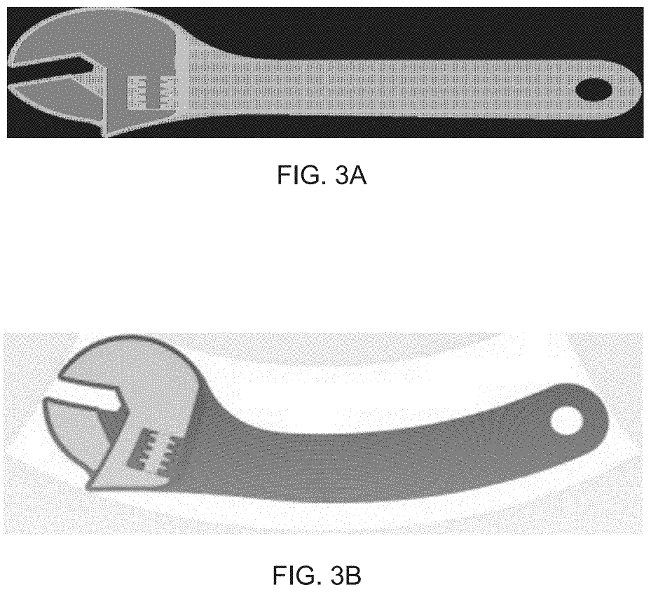

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more radiation sources 18, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Radiation source 18 serves for curing or solidifying the modeling material formulation. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention the system dispenses digital material formulation for at least one of the layers.

The phrase “digital material formulations”, as used herein and in the art, describes a combination of two or more material formulations on a pixel level or voxel level such that pixels or voxels of different material formulations are interlaced with one another over a region. Such digital material formulations may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Published Application No. 20100191360, the contents of which are hereby incorporated by reference.

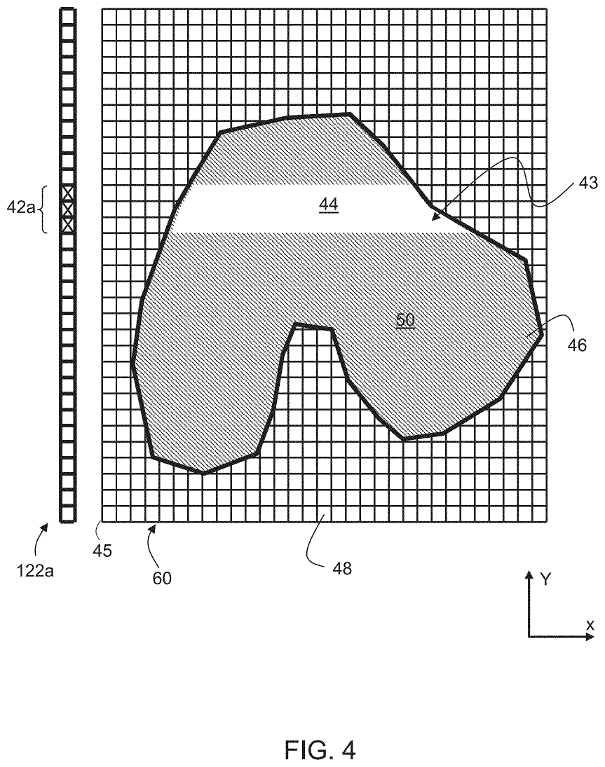

It is recognized that imperfections in the fabricated object may occur, for example, when one or more nozzles of the dispensing head are wholly or partially blocked, defective or non-functional. FIG. 4 is a schematic illustration of an array of nozzles 122a in which there are three defective nozzles, designated by numeral 42a. Also illustrated in FIG. 4 is a top view of a layer 50 formed of occupied locations 46 dispensed by nozzles 122a, and a bitmap 60 defined with respect to a reference frame having an origin 45. For better understanding of the relationship between layer 50 and bitmap 60, layer 50 overlays bitmap 60. The elements of bitmap 60 which are not overlaid by layer 50 represent void locations 48. It is to be understood that in reality there is no overlaying relation between layer 50 and bitmap 60, because layer 50 is a physical object while bitmap 60 is virtual. Nevertheless, both occupied locations 46 and void locations 48 correspond to physical locations on layer 50.

FIG. 4 shows layer 50 as formed when the relative motion between the dispensing heads and the tray during the dispensing of building material formulation is along a straight line (e.g., using system 110). The skilled person, provided with the details described herein, would know how to adjust the drawing to the case of a rotary relative motion (e.g., when layer 50 is formed using system 10).

When the dispensing head includes one or more defective nozzles 42a, there is an insufficient amount of, or no, building material in target locations visited by the defective nozzles. Such target locations are referred to herein as “defective locations”, and are designated in FIG. 4 by reference numeral 44. Note that not all target locations which are not occupied by building material are defective. One of ordinary skill in the art would appreciate the difference between defective locations 44 and void locations 48, the latter being defined as target locations which are not designated to be occupied by building material.

As illustrated in FIG. 4, the existence of defective nozzles 42a results in the formation of defective sectors 43 of missing or insufficient building material over layer 50.

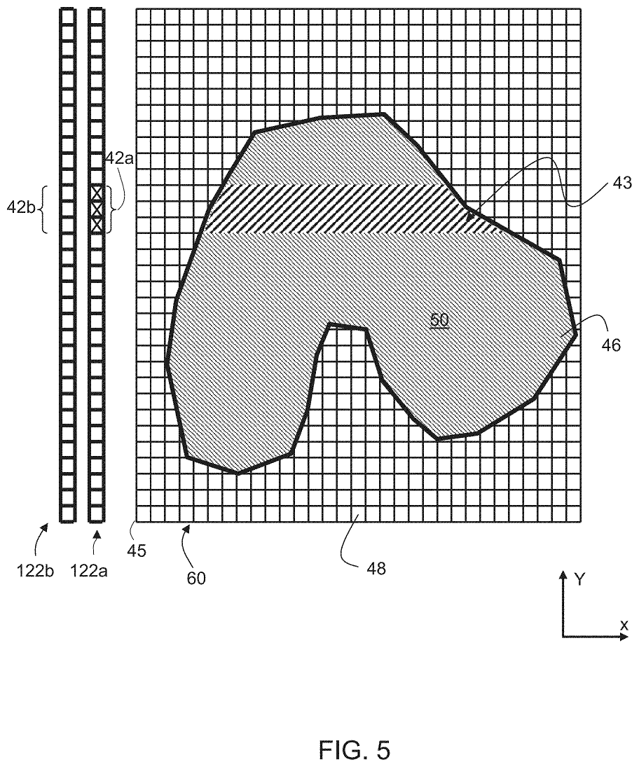

FIG. 5 is a schematic illustration of a situation in which there are two aligned arrays 122a and 122b. The nozzles 42a of array 122a are defective, as in FIG. 4. The nozzles of array 122b that are aligned with defective nozzles 42a are shown at 42b. Suppose that nozzles 42b function properly (not defective). When both arrays 122a and 122b are instructed to form layer 50, nozzles 42b dispense the appropriate amount of building material formulation in sector 43, but defective nozzles 42a either do not dispense building material formulation at all, or dispense an insufficient amount of building material formulation. As a result, there is typically a lesser amount of material in sector 43 than in the other sectors of layer 50. When arrays 122a and 122b dispense different types of building material formulations, the ratio between the formulations dispensed at sector 43 is different than the intended ratio, resulting in a final object in which the properties at sector 43 are different than the pre-designed properties.

For example, when arrays 122a and 122b dispense building material formulations of different colors, the existence of defective nozzles 42a in array 122a may cause color errors since a reduced or no dispensing of a modeling material of a particular color from defective nozzles 42a reduces the relative proportion of that particular color in sector 43. As a representative example, suppose that nozzles of array 122b are dispensing yellow material and the nozzles of array 122a are dispensing cyan material, thus collectively forming a color that is perceived as green. When one or more of the nozzles of array 122a (e.g., nozzles 42a) is defective, the formed color at sector 43 is perceived is more yellowish than desired, since it has larger relative amount of yellow. Since this error is typically local, the overall color of the object may appear non-uniform (yellowish spots or islands within a green region, in the present example).

Another example is when arrays 122a and 122b dispense building material formulations of different mechanical, electrical, and/or magnetic properties. In this case the existence of defective nozzles 42a in array 122a may cause errors in the mechanical, electrical, and/or magnetic properties since a reduced or no dispensing of a material of a particular property from defective nozzles 42a reduces the relative proportion of that particular property in sector 43.

Conventional solutions for the problem of defective nozzle adopt an additive compensation approach wherein the functioning nozzles 42b are used to dispense more material at, above, or near locations which a defective nozzle failed to occupy with material (see, e.g., U.S. Pat. No. 7,209,797 of the same Assignee as the present application, the contents of which are hereby incorporated by reference). The Inventor found that such an approach can solve the problem, when the functioning nozzles 42b dispense the same type of material. However, when the functioning nozzles 42b dispense a different type of material, such a solution may result in an unwanted ratio between the material dispensed by nozzles in array 122a and the material dispensed by nozzles in array 122b.

The inventor has therefore realized that the conventional additive compensation approach has a drawback, since it is necessary to have both arrays 122a and 122b configured to dispense the same material. Such a requirement reduces the number of different material formulations that can be used by a system that has a given number of nozzle arrays.

The Inventor has devised a technique that successfully addresses the problem associated with defective or non-functional nozzles, and that can be employed even when different arrays of nozzles dispense different types of material formulations. The Inventor discovered that the inventive technique can be employed in additive manufacturing of three-dimensional objects, as well as in two-dimensional printing of 2D objects such as text or images.

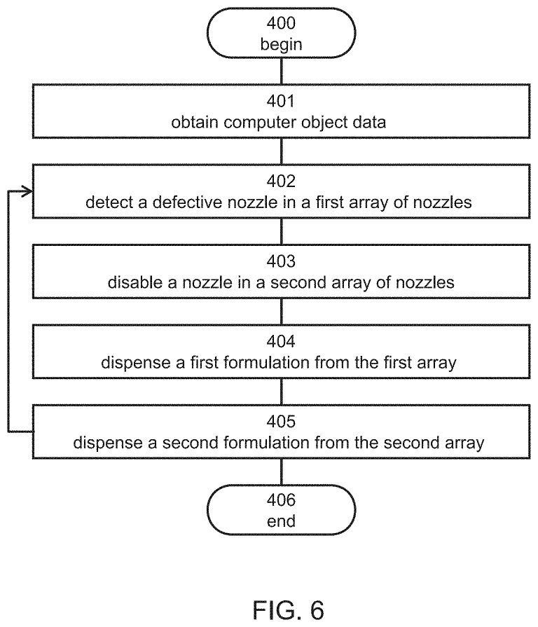

FIG. 6 is a flowchart diagram of a printing method, according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method is preferably executed using building material formulations suitable for additive manufacturing of a three-dimensional object. Alternatively, the method can be executed using ink suitable for inkjet printing of two-dimensional objects.

When the method is executed for additive manufacturing of a three-dimensional object, one or more of the operations described below can be performed by an AM system, such as, but not limited to, system 10 or system 110, wherein the controller 20 is optionally and preferably configured to transmit control signals as further detailed hereinabove so as to the execute the respective operation. When the method is executed for inkjet printing of two-dimensional objects, one or more of the operations can be executed using any type of printer having more than one array of inkjet nozzles.

For conciseness of presentation, the embodiments below are described mainly for the preferred case of AM of a three-dimensional object. It is to be understood that selected operations are also suitable for two-dimensional printing, by using inks instead of building material formulations.

Computer programs implementing the method can commonly be distributed to users on a distribution medium such as, but not limited to, a flash memory, CD-ROM, or a remote medium communicating with a local computer over the internet. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method. All these operations are well-known to those skilled in the art of computer systems.

The method can be embodied in many forms. For example, it can be embodied on a tangible medium such as a computer for performing the method steps. It can be embodied on a computer readable medium, comprising computer readable instructions for carrying out the method steps. In can also be embodied in electronic device having digital computer capabilities arranged to run the computer program on the tangible medium or execute the instruction on a computer readable medium.

The method begins at 400 and optionally and preferably continues to 401 at which computer data are received. Preferably, the computer object data collectively pertain to a three-dimensional shape of the object, but can also pertain to two-dimensional objects, if desired.

The data can be received by a data processor (e.g., processor 24) operatively associated with the AM system. For example, the data processor can access a computer-readable storage medium (not shown) and retrieve the data from the medium. The data processor can also generate the data, or a portion thereof, instead of, or in addition to, retrieving data from the storage medium, for example, by means of a computer aided design (CAD) or computer aided manufacturing (CAM) software. For example, the data processor can receive the computer object data that correspond to the object to be manufactured, and generate the computer object data that correspond to the sacrificial structure.

When the method is executed for AM of a three-dimensional object, the computer object data typically includes a plurality of slice data each defining a layer of the object to be manufactured. The data processor can transfer the data, or a portion thereof, to the controller of the AM system. Typically, but not necessarily, the controller receives the data on a slice-by-slice basis.

The data can be in any data format known in the art, including, any of the aforementioned computer object data formats.

The method optionally and preferably continues to 402 at which a defective nozzle in a first array of nozzles is detected. This can be done in more than one way.

In some embodiments of the present invention a nozzle test procedure is executed periodically. The present embodiments contemplate a nozzle test procedure in which the dispensing head dispenses test droplet series for each nozzle, forming a test pattern 62 (see FIGS. 1A and 1B) for each nozzle. The test pattern can be inspected to determine if the respective nozzle is defective when there are irregularities in the pattern (in case the respective nozzle functions partially), or when no pattern exists (in case of a complete blockage of the respective nozzle), or otherwise, that the respective is fully operative. The test pattern can be dispensed on the tray of the system, on a paper sheet, or on another suitable medium, preferably outside the region in which the 3D object is manufactured or the 2D object is printed. The test pattern can be inspected by the operator, or, more preferably by a droplet detector system 64, such as, but not limited to, an optical system that analyzes pattern 62 to detect, for each nozzle, whether the pattern exists and whether there are irregularities in the pattern. The optical system can be positioned above the tray, as illustrated in FIGS. 1A and 1B. The optical system can include an imaging system or an optical scanner that captures an image of pattern 62 and performs the analysis of pattern 64 by means of image processing.

The present embodiments also contemplate a nozzle test procedure in which the dispensing head dispenses test droplets in nozzle-by-nozzle sequence into a waste container 66. In these embodiments, droplet detector system 64 can be an optical system (e.g., an imaging device or an optical scanner) positioned on or near the tray of the AM system (see FIG. 1A) to receive a view of the orifice plate of the dispensing heads, and configured to analyze the droplets while emerging from each nozzle. Also contemplated are embodiments in which system 64 is configured to weigh container 66 wherein the determination if the respective nozzle is defective is based on the difference in the weight of container 64 before and after the dispensing. In these embodiments system 64 can comprise, for example, a load cell.

In some embodiments of the present invention, droplet detector system 64 is an optical system (e.g., an imaging system or a scanner) positioned to receive a view of the droplets once dispensed to fabricate the 3D or 2D object. In these embodiments droplet detector system 64 is preferably positioned above the tray (e.g., on the printing block 128) to receive a side view of the dispensed droplets.

In any of the embodiments in which droplet detector system 64 is employed, at least part of the analysis can be performed by the controller or data processor of the AM system.

When operation 402 is not executed, information pertaining to the defective nozzles is optionally and preferably received, for example, from the data processor or from the AM system. The data processor can receive this information from the user interface.

The method optionally and preferably continues to 403 at which a nozzle is disabled in a second array of nozzles, where the second array is different from the first array. This operation is optionally and preferably performed by the controller of the AM system. The nozzle to be disabled is optionally and preferably selected to as to locally maintain a ratio between the building material formulations dispensed by the two arrays. For example, suppose that the first array dispenses a first formulation and the second array dispenses a second formulation. Suppose further that it is desired to fabricate a particular region of an object in which voxels of the first formulation are interlaced with voxels of the second formulation at a p:q ratio, so that an area of the layer that includes p+q voxels has p voxels of the first formulations and p voxels of the second formulation (e.g., in an interlaced arrangement therebetween). Suppose in addition that k₁ of the nozzles of the first array that are to dispense the first formulation in the particular region are defective. In this case, the method optionally and preferably disables k₂ of the nozzles of the second array that are to dispense the second formulation in the particular region, where k₂ is selected such that |(p−k₁)/(q−k₂)| is sufficiently close to p/q (e.g., with a tolerance of less than 20% or less than 10% or less than 5% from p/q).

Preferably, the array pitch of the nozzle that is disabled at 403 is at the same or approximately the same array pitch of the defective nozzle, except that it belongs to a different array.

As used herein, “array pitch” of a nozzle refers to a location of the nozzle along the indexing direction, in dimensionless units corresponding to the distance between adjacent nozzles in the array. Thus, for example, the first nozzle of an array along the indexing direction has an array pitch 1, the second nozzle of an array along the indexing direction has an array pitch 2, etc.

In various exemplary embodiments of the invention the difference between the array pitch of the nozzle that is disabled at 403 and the array pitch of the defective nozzle, in absolute value, is 5 or less, or 3 or less, or 2 or less, or 1 or less, e.g., 0. For example, referring again to FIG. 5, when nozzles 42a of array 122a are found to be defective (e.g., by executing operation 402), nozzles 42b, which have the same locations along array 122b as the locations of nozzles 42a along array 122a, are disabled at 403.

According to preferred embodiments of the present invention, the nozzle that is disabled at 403 is not a defective nozzle (namely a fully functioning nozzle).

The method proceeds to 404 at which a first building material formulation is dispensed from non-defective nozzles of the first array, and to 405 at which a second building material formulation is dispensed from non-disabled nozzles of the second array. In some embodiments of the present invention the first and the second formulations are of different colors. In some embodiments of the present invention the first and the second formulations are of different mechanical properties (e.g., rigidity, flexibility, hardness, elasticity, and/or other properties).

Operations 404 and 405 can be executed simultaneously or serially, and are optionally and preferably continued until the final 2D object is printed, or continued in a layer-wise manner until a final 3D object is fabricated. Optionally, the method loops back to 402 at least once before the 2D or 3D object is completed, so as to determine whether or not there is a change in the number of defective nozzles.

The method ends at 406.

The method as shown in FIG. 6 is advantageous since it reduces the likelihood for non-uniformities in the ratio between the formulations (e.g., color non-uniformities) while maintaining flexibility in selecting the number of nozzle arrays that are used to dispense each color. Unlike the conventional solution for handling the defective nozzles problem, the solution according to preferred embodiments of the present invention employs a subtractive approach wherein nozzles that are otherwise functional are disabled to maintain the relative amounts of the dispensed materials.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

Experiments were performed to investigate the ability of the technique of the present embodiments to reduce color non-uniformities.

A block, about 90 mm in length (along the x direction), about 40 mm in width (along the y direction), and about 10 mm in height (along the z direction) was printed using a three-dimensional inkjet printing system marketed by Stratasys® Ltd., Israel, under the tradename Stratasys J750™.

The printing system was operated to fabricate the block by dispensing two material formulations in a manner that, for example, voxels in which cyan color was dispensed were interlaced with voxels in which yellow color was dispensed, forming a digital material formulation perceived as green. The ratio of cyan to yellow is predetermined according to the shade of green desired to be obtained. Optionally, in this example, a single voxel may include both droplets of cyan and droplets of yellow in a pre-determined ratio according to the shade of green desired and/or the size of the voxel.

The colors were printed along the x direction. The y offset between the nozzles that dispensed cyan formulation and the nozzles that dispensed yellow formulation were less than 0.1 mm.

The array of nozzles dispensing the cyan formulation had several defective nozzles. When the block was printed without disabling nozzles dispensing the yellow formulation, significant color uniformity (bluish regions) was observed.

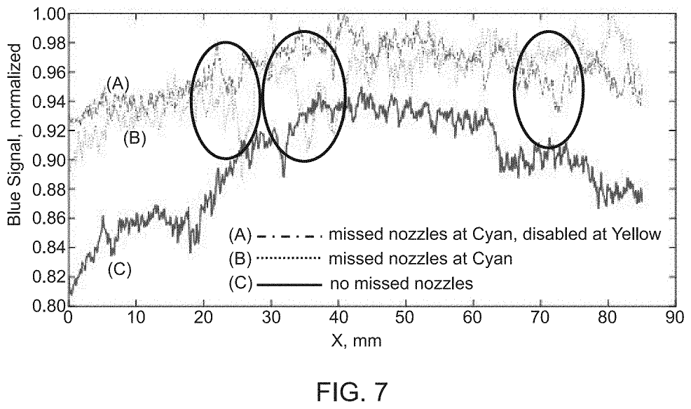

The defective nozzles in the array were identified by their indices. The block was then printed while disabling operation of the nozzles in the array of nozzles dispensing the yellow formulation. The disabled nozzles had the same indices as the indices of the defective nozzles. The results are shown in FIG. 7 which shows distributions of the blue signal at the images of the block printed with (dash-dot line A) and without (dotted line B) disabling the functioning nozzles dispensing the yellow formulation. The solid line (C) shows a control case in which there are no defective nozzles and no nozzle was disabled. The solid line has been shifted down for clarity of presentation. FIG. 7 demonstrates that color uniformity was improved by disabling functioning nozzles as described hereinabove.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A method of printing using an inkjet printing system having plurality of arrays of nozzles, the method comprising:
detecting a defective nozzle in a first array of nozzles;
disabling a nozzle in a second array of nozzles;
dispensing a first material formulation from nozzles of said first array, other than said defective nozzle; and
dispensing a second material formulation from nozzles of said second array, other than said disabled nozzle.

2. The method according to claim 1, further comprising selecting said nozzle in said second array so as to locally maintain a ratio between said first and said second material formulations.

3. The method according to claim 1, wherein a location of said defective nozzle along said first array, and a location of said disabled nozzle along said second array of nozzles, are within 0 to 5 array pitch units from each other.

4. The method according to claim 1, comprising detecting a plurality of defective nozzles in said first array of nozzles, disabling a plurality of nozzles in said second array of nozzles; dispensing said first material formulation from nozzles of said first array, other than said defective nozzles; and dispensing said second material formulation from nozzles of said second array, other than said disabled nozzles.

5. The method according to claim 1, wherein said first material formulation and said second material formulation are of different colors.

6. The method according to claim 1, wherein said first material formulation and said second material formulation have different mechanical properties.

7. The method according to claim 1, wherein said first material formulation and said second material formulation have different electrical properties.

8. The method according to claim 1, wherein said first material formulation and said second material formulation have different magnetic properties.

9. The method according to claim 1, wherein said dispensing said first material formulation, and said dispensing said second material formulation is in an interlaced manner.

10. The method according to claim 1, wherein said first array of nozzles and said second array of nozzles are both located in one dispensing head.

11. The method according to claim 1, wherein said first array of nozzles is located in a first dispensing head, and said second array of nozzles is located in a second dispensing head.

12. The method according to claim 1, comprising detecting an additional defective nozzle intermittently with said dispensing of said first and said second material formulations.

13. The method according to claim 1, wherein said detecting is executed automatically by an optical scanner.

14. The method according to claim 1, wherein said inkjet printing system is a three-dimensional inkjet printing system, and said first and said second material formulations, are respectively a first and a second building material formulations.

15. The method according to claim 1, wherein said inkjet printing system is a two-dimensional inkjet printing system, and said first and said second material formulations, are respectively a first and a second ink material formulations.

16. An inkjet printing system, comprising:
a plurality of arrays of nozzles; and
a controller configured for receiving information pertaining to a defective nozzle in a first array of nozzles, for disabling a nozzle in a second array of nozzles, and for controlling said first array to dispense a first material formulation from nozzles of said first array, other than said defective nozzle, and for controlling said second array to dispense a second material formulation from nozzles of said second array, other than said disabled nozzle.

17. The system of claim 16, comprising:
an optical scanner; and
an image processor configured for receiving scans from said optical scanner, processing said scans to detect said defective nozzle in said first array of nozzles, and transmitting said information to said controller.

18. The system according to claim 16, wherein said controller is configured for selecting said nozzle in said second array so as to locally maintain a ratio between said first and said second material formulations.

19. The system according to claim 16, wherein a location of said defective nozzle along said first array, and a location of said disabled nozzle along said second array of nozzles, are within 0 to 5 array pitch units from each other.

20. The system according to claim 16, wherein said controller is configured for detecting a plurality of defective nozzles in said first array of nozzles, disabling a plurality of nozzles in said second array of nozzles; dispensing said first material formulation from nozzles of said first array, other than said defective nozzles; and dispensing said second material formulation from nozzles of said second array, other than said disabled nozzles.

21. The system according to claim 16, wherein said first array of nozzles and said second array of nozzles are both located in one dispensing head.

22. The system according to claim 16, wherein said first array of nozzles is located in a first dispensing head, and said second array of nozzles is located in a second dispensing head.

23. The system according to claim 16, wherein said controller is configured for detecting an additional defective nozzle intermittently with said dispensing of said first and said second material formulations.

24. The system according to claim 16, being a three-dimensional inkjet printing system, wherein said first and said second material formulations, are respectively a first and a second building material formulations.

25. The system according to claim 16, being a two-dimensional inkjet printing system, and said first and said second material formulations, are respectively a first and a second ink material formulations.
